(19) United States
(12) Patent Application Publication
(10) Pub. No.: US 2013/0163871 A1
(43) Pub. Date: Jun. 27, 2013

(54) SYSTEM AND METHOD FOR SEGMENTING IMAGE DATA TO IDENTIFY A CHARACTER-OF-INTEREST

(71) Applicants: Joseph Salvo, Schenectady, NY (US); John Carbone, Ballston Spa, NY (US); Lynn Ann Derose, Gloversville, NY (US); Adam McCann, Clifton Park, NY (US); William Leonard, Saratoga Springs, NY (US)

(72) Inventors: Joseph Salvo, Schenectady, NY (US); John Carbone, Ballston Spa, NY (US); Lynn Ann Derose, Gloversville, NY (US); Adam McCann, Clifton Park, NY (US); William Leonard, Saratoga Springs, NY (US)

(73) Assignee: General Electric Company, Schenectady, NY (US)

(21) Appl. No.: 13/401,492

(22) Filed: Feb. 21, 2012

Related U.S. Application Data
(63) Continuation-in-part of application No. 13/335,626, filed on Dec. 22, 2011, now abandoned.

(51) Int. Cl. G06K 9/18; G06K 9/34

(52) U.S. Cl. 382/176

(57) ABSTRACT

A system and method of processing an acquired image to identify characters-of-interest in the acquired image. The method includes obtaining image data of a surface of an object. The image data includes a plurality of image pixels having corresponding light intensity signals. The light intensity signals are based on whether the corresponding image pixel correlates to a morphological change in the surface of the object. The method also includes determining a line section of the image data. The line section includes one of the character lines and has character image portions. The method also includes analyzing the light intensity signals of the image pixels in the character image portions to determine a common height of the characters-of-interest. The method also includes removing extraneous areas of the character image portions based on the common height of the characters-of-interest to provide trimmed image portions.

### CROSS-REFERENCE TO RELATED APPLICATIONS

The present application is a continuation-in-part of U.S. application Ser. No. 13/335,626 (the '626 Application), which has the same title as the present application and was filed on Dec. 22, 2011. The '626 Application is hereby incorporated by reference in its entirety.

### BACKGROUND

A variety of items used in commerce include machine-readable markings that provide information about the items. The information may not only be used to determine a price of the item (e.g., when checking out at a supermarket) as in some cases, but can also be used to determine a production/usage history of an item (e.g., lot number, date of manufacture, and period of use). Items are often labeled with removable tags, or containers that hold the items can be labeled. In some instances, the markings are physically part of the item. For example, an automotive part can be directly marked through dot peening, etching, hammering, molding, casting, and the like.

Items that are marked may be exposed to conditions that are capable of damaging the markings. For example, a machine part may be used and then refurbished for a second lifetime of use. However, during use of the machine part or during the refurbishing process, the markings may become scratched, worn, soiled, or otherwise rendered more difficult to read. In some cases, if any one of the characters is unreadable for an individual or scanner, the part may undergo more extensive analysis to identify the part or it may even be scrapped completely.

### BRIEF DESCRIPTION

In accordance with various embodiments, a character-recognition system is provided that includes an imager configured to acquire an image of an object. The acquired image includes a surface of the object having characters-of-interest thereon that are arranged along multiple characters lines. The characters-of-interest are defined by morphological changes in the surface. The system also includes a segmentation module that is configured to obtain image data based on the acquired image. The image data includes a plurality of image pixels having corresponding light intensity signals. The light intensity signals are based on whether the corresponding image pixel correlates to one of the morphological changes in the surface of the object. The segmentation module is also configured to determine a line section of the image data. The line section includes one of the character lines and has character image portions. The character image portions include corresponding characters-of-interest therein. The segmentation module is also configured to analyze the light intensity signals of the image pixels in the character image portions to determine a common height of the characters-of-interest in the corresponding character line of the line section. The segmentation module is also configured to remove extraneous areas of the character image portions based on the common height of the characters-of-interest thereby providing trimmed image portions.

In accordance with yet other various embodiments, a non-transitory computer readable medium for segmenting an acquired image of an object using at least one processor is provided. The image includes a surface of the object having characters-of-interest thereon that are arranged along multiple characters lines. The computer readable medium includes instructions to command the processor to obtain image data of the surface of the object. The image data includes a plurality of image pixels having corresponding light intensity signals. The light intensity signals are based on whether the corresponding image pixel correlates to a morphological change in the surface of the object. The processor is also commanded to determine a line section of the image data. The line section includes one of the character lines and has character image portions. The character image portions include corresponding characters-of-interest therein. The processor is also commanded to analyze the light intensity signals of the image pixels in the character image portions to determine a common height of the characters-of-interest in the corresponding character line of the line section. The processor is also commanded to remove extraneous areas of the character image portions based on the common height of the characters-of-interest thereby providing trimmed image portions.

In accordance with yet other various embodiments, a method of processing an acquired image to identify characters-of-interest in the acquired image is provided. The method includes obtaining image data of a surface of an object. The image data includes a plurality of image pixels having corresponding light intensity signals. The light intensity signals are based on whether the corresponding image pixel correlates to a morphological change in the surface of the object. The method also includes determining a line section of the image data. The line section includes one of the character lines and has character image portions. The character image portions include corresponding characters-of-interest therein. The method also includes analyzing the light intensity signals of the image pixels in the character image portions to determine a common height of the characters-of-interest in the corresponding character line of the line section. The method also includes removing extraneous areas of the character image portions based on the common height of the characters-of-interest thereby providing trimmed image portions.

### BRIEF DESCRIPTION OF THE DRAWINGS

FIG. 1 is a schematic block diagram that illustrates an exemplary character-recognition system formed in accordance with one embodiment.

FIG. 2 is a flowchart illustrating a method of processing an acquired image in accordance with one embodiment.

FIG. 3 shows the acquired image at various stages of processing in which the light intensity signals of at least some of the image pixels are modulated.

FIG. 4 illustrates a base image and a plurality of line sections that are derived from the base image.

FIG. 5 illustrates an analyzing operation to determine the line sections of FIG. 4.

FIG. 6 illustrates a line section that undergoes contrast spreading in accordance with various embodiments.

FIG. 7 illustrates an analyzing operation to determine character image portions within one line section.

FIG. 8 further illustrates the analyzing operation of FIG. 7 in which a breakline that separates adjacent character image portions is determined.

FIG. 9 illustrates an analyzing operation to determine a common height of characters-of-interest in a first line section.

FIG. 10 illustrates an analyzing operation to determine a common height of characters-of-interest in a second line section.

FIG. 11 illustrates different stages of processing a trimmed image portion to obtain a compressed pixel image.

FIG. 12 illustrates a pixel image and a corresponding feature vector that is converted from the pixel image by the system of FIG. 1.

FIG. 13 illustrates training a sparse distributed module (SDM) and/or providing a suggested identity of a character-of-interest using the system of FIG. 1.

FIG. 14 is a flowchart illustrating a method of identifying characters from an object having physical markings.

FIG. 15 illustrates exemplary binary images of characters-of-interest that may be identified by the system of FIG. 1.

### DETAILED DESCRIPTION

The following detailed description of certain embodiments will be better understood when read in conjunction with the appended drawings. To the extent that the Figures illustrate diagrams of functional blocks of various embodiments, the functional blocks are not necessarily indicative of the division between hardware. Thus, for example, one or more of the functional blocks may be implemented in a single piece of hardware or multiple pieces of hardware. It should be understood that the various embodiments are not limited to the arrangements and instrumentality shown in the drawings. Additionally, the system blocks in the various Figures or the steps of the methods may be rearranged or reconfigured.

As used herein, an element or step recited in the singular and proceeded with the word “a” or “an” should be understood as not excluding plural of said elements or steps, unless such exclusion is explicitly stated. Furthermore, references to “one embodiment” or “an exemplary embodiment” and the like are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

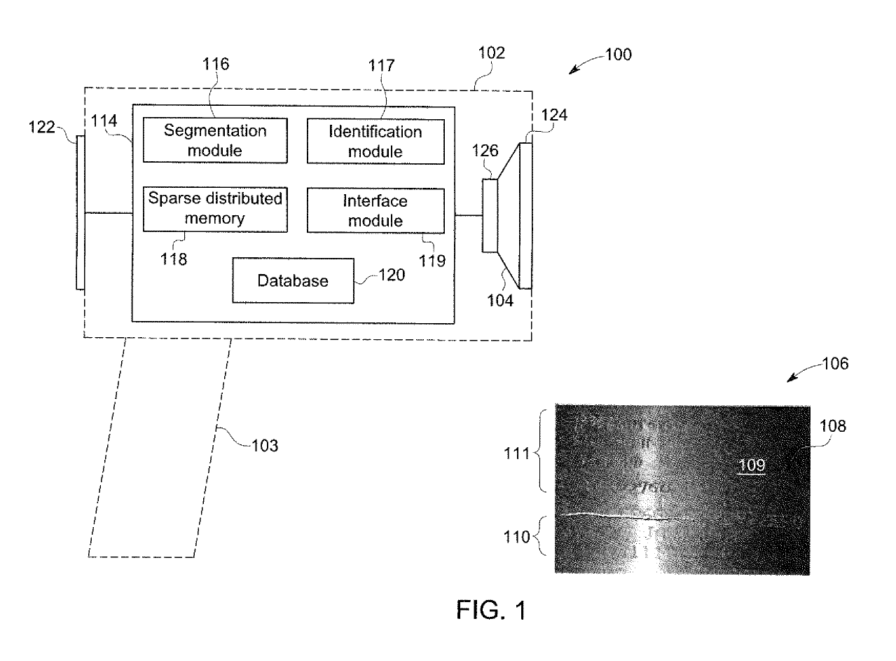

FIG. 1 schematically illustrates an exemplary character-recognition system (or reader) 100 formed in accordance with one embodiment. The system 100 is configured to analyze an image of a surface of an object that has markings that include characters or symbols thereon and provide an indication or estimation as to the identity of a character(s)-of-interest. The system 100 may also be configured to acquire the image of the surface of the object and/or process the acquired image to facilitate identification of the character(s)-of-interest. Although not required, at least one of the characters-of-interest may be difficult to read by an individual or conventional reader system. For instance, the characters-of-interest may be scratched, chipped, dirtied, improperly printed, have a small type-font, or are otherwise difficult to read.

In various embodiments, the markings are configured to identify and/or provide information about the object that has the markings. For example, the markings can be used to determine any information about the manufacture or subsequent use of the object, such as a date of production, the particular manufacturer or plant that made the object, composition of the material(s) used, when and by whom the object was inspected, when and how long the object was used, the machine that used the object, and the like.

Embodiments described herein may be used to analyze imaged markings on an object. The imaged markings may include characters or symbols that are part of an identification system. In particular embodiments, the markings are physical markings. As used herein, “physical markings” include markings that are at least partially made by morphological changes along the surface of the object. As opposed to two-dimensional markings made on paper, physical markings may be three-dimensional. For example, objects described herein may have physical markings that were formed by changing a relatively smooth surface through dot peening, etching, hammering, scratching, stamping, impressing, and the like. Physical markings may also be made through molding, casting, and the like in which, for example, a material is poured into a mold and allowed to cure, set, or otherwise harden. The above examples are not intended to be limiting and, as such, physical markings could be made through other processes. Moreover, the use of the term “markings” is not intended to be limited to a particular language or identification system. For example, the markings may include letters of a recognizable language and numbers (i.e., alphanumeric characters). The markings may also include other recognizable symbols (e.g., Greek symbols) or symbols specifically designed for a particular identification system. An exemplary identification system may include the letters of the English alphabet (A, B, C. . . ) and/or the numbers 0-9.

An object may include more than one type or style of marking. For example, at least one of the physical markings may be cast or molded by the manufacturer while other physical markings may be dot peened by the vendor or user of the object. Markings may be located on a planar surface or a surface that has some curvature or contour.

Although embodiments described herein are described with particular reference to physical markings, other embodiments may be used to image and analyze two-dimensional markings. For example, the imaged markings could be made by applying ink or paint to cardboard containers, envelopes, paper, or other substantially planar surfaces. As such, when the terms “markings,” “characters,” or “characters-of-interest” are not modified by “physical,” the term includes two-dimensional markings, characters, symbols, and the like.

The objects imaged may be any item capable of having the markings made thereon. In particular embodiments, the object is a mechanical item configured to be used in a machine or other industrial application in which the object has physical markings on surface(s) of the object. For example, the objects could be automotive parts or aircraft parts (e.g., rotors). The objects can be large and heavy such that the objects must be scanned one at a time by an individual. The objects can also be small, such as items used with handheld electronic devices. The objects can also be found or used in environments that increase the likelihood of the physical markings being damaged or dirtied.

With respect to FIG. 1, the system 100 may include various components, assemblies, and systems (including sub-systems) that interact with each other to provide a suggested identity of a character(s)-of-interest. The system 100 may also be configured to acquire images that include the character(s)-of-interest. For example, the system 100 may include an imager 104 that is configured to capture one or more images 106 of markings 110, 111 on an object 108. The object 108 has a surface 109 that may have a small, convex curvature. As shown in the exemplary image 106, the markings 110, 111 include physical markings 110 that are dot-peened onto the surface 109 and physical markings 111 that are scratched by an individual or machine-penned onto the surface 109. Other physical markings can be cast or molded with the object 108 during manufacture.

In the illustrated embodiment, the system 100 may include a single housing 102 that is configured to hold the imager 104 and other components of the system 100. The housing 102 may be sized and shaped for an individual to hold and carry and may include a grip 103. In such embodiments, the system 100 may resemble a handheld price scanner. Alternatively, the system 100 and the housing 102 are not sized for an individual to carry. By way of one example only, the system 100 could be a part of an assembly line or other automated system in which the objects are imaged as the objects pass by on a conveyor belt. The alternative system 100 could have a stationary position with respect to the conveyor belt.

The imager 104 may include a lens or lenses 124 and an imaging sensor 126 configured to acquire the images 106. The imaging sensor can be a charge-coupled device (CCD), a complimentary metal oxide semiconductor (CMOS), or another type of imaging sensor. The imager 104 may include other features that may be used with imagers/cameras, such as an auto-focus mechanism, viewfinder, and/or a lighting system that is configured to illuminate the surface 109 of the object 108 during acquisition of the image 106. In addition, the imager 104 and/or the system 100 may include filters for detecting light of a predetermined wavelength or range. For example, the light system may include an LED source light (e.g., infrared) that illuminates the object including the markings. The LED light source may be positioned to illuminate the markings at a shallow angle. A bandpass filter may permit the reflected light to pass through and be detected by the imager 104, but block or filter, for example, the ambient light.

As shown, the system 100 may also include a user interface 122 that may receive user inputs from the user and/or communicate information to the user. For instance, the user interface 122 may include a display that identifies the objects scanned by the system 100 or provides suggested identities of the characters-of-interest and/or the objects. As used herein, providing a “suggested identity” and like terms may include providing an ideal character (e.g., the letter or number without any noise) or may include providing a closer estimation of how the character-of-interest should appear, which may include some noise. For example, a character that has some noise may be less clear (e.g., appear fuzzy), but may still be identifiable by a user. In some embodiments, the user can enter information or instructions to assist the system 100 in identifying the characters-of-interest.

As shown in FIG. 1, after acquiring the image 106, image data that forms the image 106 may be communicated to a system controller 114. The system controller 114 may include one or more processors or modules, illustrated as modules 116-120, that communicate directly or indirectly with one another. The system controller 114 is illustrated conceptually as a collection of modules, but may be implemented utilizing any combination of dedicated hardware boards, DSPs, processors, and the like. The system controller 114 can also be implemented utilizing an off-the-shelf PC with a single processor or multiple processors, with the functional operations distributed between the processors. The modules described herein also may be implemented utilizing a hybrid configuration in which certain modular functions are performed utilizing dedicated hardware, while the remaining modular functions are performed utilizing an off-the-shelf PC and the like. The modules also may be implemented as software modules within a processing unit or system memory.

The modules 116-120 include a segmentation module 116, an identification module 117, a sparse distributed memory (SDM) module 118, an interface module 119, and a database 120. The segmentation module 116 is configured to analyze the image 106 and convert at least a portion of the markings 110, 111 into a corresponding feature vector (described in greater detail below). For example, in some embodiments, the segmentation module 116 separates the image into character image portions to isolate characters-of-interest. The character image portions of the image 106 may then be converted into pixel (e.g., binary) images and analyzed to generate corresponding feature vectors. The identification module 117 is configured to receive the feature vector and, for at least one of the characters-of-interest, use the SDM module 118 to identify the character(s)-of-interest. The interface module 119 may be configured to communicate with the other modules 116-118, 120 and the user interface 122.

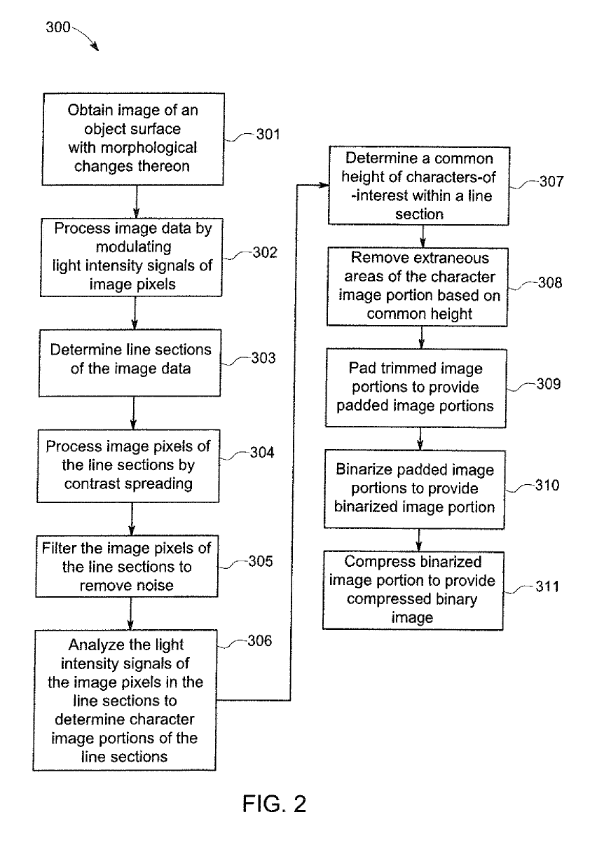

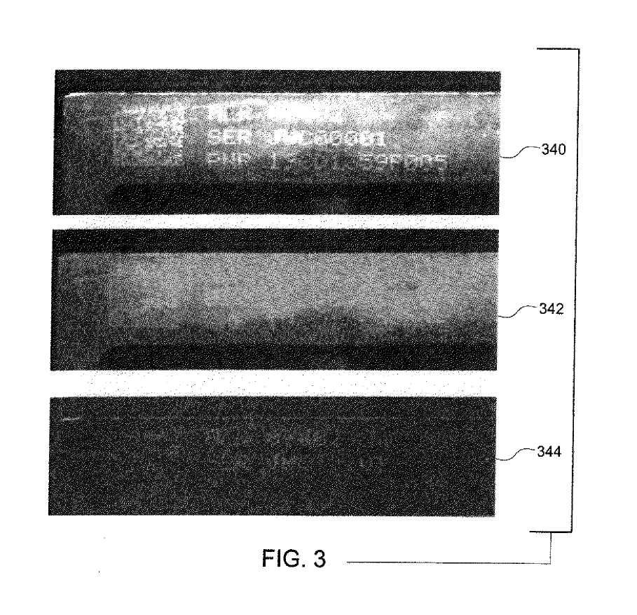

FIG. 2 is a flow chart illustrating a method 300 of processing an image. The following description of the method 300 is referenced with respect to FIGS. 3-11. The method 300 may be configured to process an image, such as the acquired image 106 (FIG. 1) or an acquired image 340 (FIG. 3), to provide a feature vector that is then used to provide a suggested identity of a character-of-interest. Embodiments described herein also include non-transitory computer readable media that have instructions to command a processor (including multiple processors) to perform at least a portion of the method 300. The system 100, including the segmentation module 116, may also perform at least a portion of the method 300. It should be noted that embodiments described herein are not required to perform each operation of the method 300 or perform each operation as described below. As such, the following description of the method 300 is intended to be illustrative and not restrictive.

The system 100 may be configured to obtain or acquire at 301 an image 340 of an object surface having morphological changes that include characters-of-interest. In some embodiments, the image 340 may be acquired by the imager 104 (FIG. 1). For example, a CCD or CMOS having millions of pixel elements (or image sensor elements) may detect light photons from the object surface and convert the photons into corresponding electrical signals. The electrical signals from the pixel elements may constitute image data and may be used to form an image. The imager and/or lighting system may be configured to filter the light that is detected by the pixel elements. When light is reflected from a surface that includes morphological changes, a number of light photons received from a smooth portion of the surface will differ from a number of light photons received from a portion that includes the morphological changes (e.g., dot-peening, scratching, casting, dirt, and the like). In the illustrated embodiment, the system 100 acquires the image 340. However, in other embodiments, the system 100 may receive the image 340 from another source.

The image 340 or image data may include a plurality of image pixels in which each image pixel has a corresponding light intensity signal. Each image pixel may or may not directly correlate to a single pixel element of the imager. The characteristics of the light intensity signals may be based on whether the corresponding image pixel corresponds to a morphological change in the surface of the object. Morphological changes include changes in depth and/or angle of the surface relative to a depth and/or angle of a smooth portion (e.g., unwritten portion) of the surface of the object. The morphological changes may reflect light in a different manner than the smooth portion of the surface.

As the morphological change on a surface increases, a change in a light intensity signal with respect to a baseline signal may increase. As one example in which the characters on the surface are dot-peened, the image pixels that correspond to the characters will have a light intensity signal that differs from a light intensity signal of image pixels corresponding to a smooth portion of the surface. A light intensity signal corresponding to a smooth portion of the surface may be characterized as a baseline signal, and the light intensity signals corresponding to the morphological changes along the surface may be greater than or less than the baseline signal. Depending upon the implementation of the system 100 and the manner that the characters were provided onto the surface, the baseline signal may correspond to brighter image pixels or the baseline signal may correspond to darker image pixels.

The system 100 may process (or pre-process) at 302 the image data. The processing at 302 may occur in the imager 104 or within one of the modules, such as the segmentation module 116. The acquired image 340 is shown in FIG. 3. In various embodiments, the processing at 302 includes modulating or changing the light intensity signals of the image pixels of the acquired image 340. For example, the imager 104 and/or the system 100 may identify a small group of image pixels that have a higher intensity value than surrounding image pixels. If the intensity values of the image pixels in the group are significantly higher than the intensity values of the surrounding image pixels, the image pixels in the group may be assigned an intensity value that is the average of the intensity values of the surrounding image pixels. However, the above is just one example of processing the acquired image 340 and other manners of modulating the light intensity signals of select image pixels may be used. The processing operation at 302 may also include digitally subtracting the secondary image 342 from the acquired image 340 to provide a processed (or preprocessed) image 344. In some cases, the processed image 344 appears darker than the acquired or secondary images 340, 342 as shown in FIG. 3.

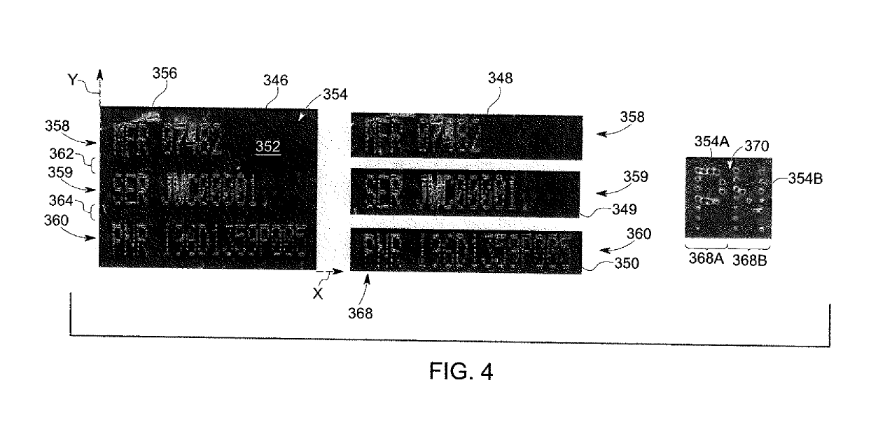

The method 300 can also include determining at 303 line sections of the image data. For instance, as shown in FIG. 4, a base image 346 may be analyzed to determine line sections 348-350. The base image 346 may be based upon the acquired image 340. For example, the based image 346 may be the acquired image 340 without modification, the processed image 344 (FIG. 3), or another processed image that is derived from the acquired image 340. As shown, the base image 346 includes a smooth surface 352 having morphological changes (or physical markings) 354, 356. The morphological changes include characters-of-interest 354 and other morphological changes 356, such as scratches and/or dirt. In some cases, the morphological changes 356 may extend into and through the characters-of-interest 354. The morphological changes 356 may be characterized as unintended or undesirable because the morphological changes 356 may render it more difficult to identify the characters-of-interest 354.

The characters-of-interest 354 are arranged in multiple character lines 358-360. Each of the character lines 358-360 includes a series of characters-of-interest 354 that are arranged or aligned in one direction along an X-axis. The characters-of-interest 354 may have a substantially equal height or, in other embodiments, different heights (e.g., upper-case or lower-case letters). The height may be measured along a Y-axis that is perpendicular to the X-axis. In some embodiments, the characters-of-interest 354 along a first character line may have a substantially equal height, and the characters-of-interest 354 along a second character line may have a substantially equal height. The heights associated with the first and second character lines may be the same or different. For example, character line(s) provided by the manufacturer may be different from the character line(s) provided by the vendor or user.

The adjacent character lines 358, 359 are separated by a line spacing 362 and the adjacent character lines 359, 360 are separated by a line spacing 364. In the illustrated embodiment, the line spacings 362, 364 extend longitudinally parallel to the character lines 358-360. The line spacings 362, 364 may represent areas of the surface 352 where markings were not written or formed. In some cases, scratches to the surface 352 or dirt on the surface 352 may exist at least partially in the line spacings 362, 364.

In some embodiments, the determining at 303 of the line sections 348-350 is an estimation of where character lines are located in the image 346 and may be over inclusive to ensure that a character line is within a line section. As such, each of the line sections 348-350 includes one of the character lines 358-360. Each of the line sections 358-360 may also include a portion of one of the line spacings 362, 364. For example, each of the line sections 348, 349 may include a portion of the line spacing 362, and each of the line sections 349, 350 may include a portion of the line spacing 364.

Each of the lines sections 348-350 may also include a plurality of character image portions 368. Each character image portion 368 includes a respective character-of-interest and may also include a portion of a character spacing that extends between the character-of-interest and an adjacent character-of-interest. To illustrate in FIG. 4, the adjacent character image portions 368A, 368B include the respective characters-of-interest 354A, 354B. Each of the adjacent image portions 368A, 368B may also include a portion of a character spacing 370 located between the adjacent characters-of-interest 354A, 354B.

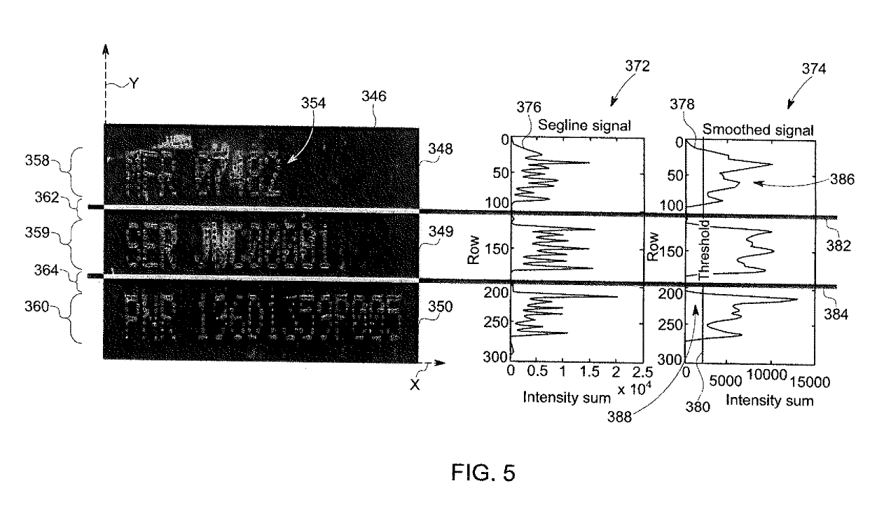

In some embodiments, the separate line sections 348-350 are determined at 303 by analyzing the intensity signals of the image pixels in the base image 346. The analyzing may identify or determine a size and location of the line spacings 362, 364 relative to a size and location of the character lines 358-360. Various algorithms may be implemented for analyzing the intensity signals. For example, FIG. 5 shows the base image 346 and graphs 372, 374. The graphs 372, 374 show a relationship between rows of image pixels and intensity sums of the rows. In particular embodiments, the determining operation at 303 includes summing the intensity signals of the image pixels in a row for at least a plurality of rows in the base image 346. The summed intensity signals for one row may be referred to as the intensity sum of the row. The rows of image pixels extend parallel to the X-axis shown in FIG. 5 (or in a direction that the character lines 358-360 extend along). As shown in the graphs 372, 374, the rows of image pixels that include the character lines 358-360 will have relatively high intensity sums. However, the intensity sums of rows that correspond to the line spacings 362, 364 are relatively low.

In some embodiments, an approximate size of the line spacings 362, 364 and/or a height of the characters-of-interest 354 may be known by the system 100 (or the segmentation module 116). For example, the size of the line spacings 362, 364 or the height of the characters-of-interest 354 may be identified through the type of object, the manufacturer, and the like. In other embodiments, an operator of the system 100 may enter inputs (e.g., through the user interface 122 (FIG. 1)) that identify an approximate size of the line spacings 362, 364 or an approximate height of the characters-of-interest 354. When the system 100 analyzes the intensity sums of the rows of image pixels, the system 100 may use the size and/or height information to identify rows that are associated with the characters-of-interest 354 and rows that are associated with the line spacings 362, 364.

For example, the system 100 may identify a threshold. As shown, the graph 372 illustrates a relationship or signal trace 376 that is a function of the rows and the intensity sums. The graph 374 illustrates a modified version of the signal trace 376 in which the signal trace 376 has been smoothed to provide a smooth trace 378. As shown in the graph 374, the smooth trace 378 includes highlighted or bolded segments 386 that correspond to rows having intensity sums that exceed the threshold 380. The remaining or unbolded segments 388 do not exceed the threshold 380 and correspond to rows having intensity sums that are less than the threshold 380.

In some embodiments, the threshold 380 is a dynamic threshold 380 that is capable of changing as the segmentation module 116 analyzes the image pixels. For example, the segmentation module 116 may search for series of rows that substantially equal the known size of the line spacings 362, 364 and/or or series of rows that substantially equal the height of the characters-of-interest 354. More specifically, the segmentation module 116 may adjust the threshold 380 so that the bolded segments correspond to a series of rows that approximately equal the height of the characters-of-interest 354 of one character line and/or the unbolded segments correspond to a series of rows that approximately equal the size of the line spacings 362 or 364.

In such embodiments, the segmentation module 116 may account for at least some morphological changes 356 (e.g., unintended scratches or dirt) that are located within the line spacings 362, 364. For example, if a single scratch (not shown) exists through the line spacing 362, but the line spacing 364 does not include any substantial scratches, the intensity sums of the rows associated with the line spacing 362 may be greater than the intensity sums of the rows associated with the line spacing 364. Nonetheless, because the scratch does not significantly increase the intensity sums, the segmentation module 116 may still be able to determine a suitable threshold 380 so that the character lines and line spacings may be approximately identified.

After determining the threshold 380, the segmentation module 116 may then determine or identify the line sections 348-350 of the image data. For example, the separation lines 382, 384 shown in FIG. 5 represent where the line sections 348-350 are considered separate from each other. In some embodiments, the separation lines 382, 384 are located to extend approximately between adjacent character lines. The separation lines 382, 384 may extend through a middle of the corresponding line spacing. As shown, each line section 348-350 includes a respective character line and a portion of at least one of line spacings.

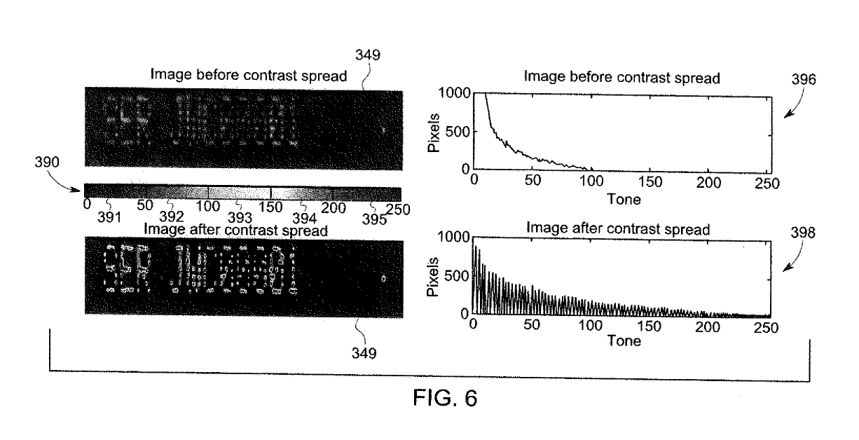

The method 300 also includes processing at 304 the line sections 348-350 by modulating the light intensity signals of the image pixels within the corresponding line section. Although the operation at 304 is described as being performed with respect to the line sections 348-350, the processing operation at 304 and other similar operations may be generally applied to the base image 346 in other embodiments. As shown in FIG. 6, the processing operation at 304 includes spreading a contrast of the image pixels. More specifically, FIG. 6 shows the line section 349 before and after the contrast spreading. When the contrast is spread, a range of possible tone values of the image pixels is increased. As shown in the graphs 396, 398, the contrast spreading increases the tone range from 0-100 to 0-250. However, other changes may be made to the tone range.

Increases in the tone range may correlate to a change in color spectrum of the image pixels. FIG. 6 shows a color spectrum 390. The spectrum 390 extends from dark blue at 391, to light blue 392, to green 393, to orange 394, and to red 395. Before contrast spreading, the colors of the image pixels in the line section 349 may range from dark blue to light blue. However, after contrast spreading, the colors of the image pixels range from dark blue to dark red. The method 300 may also include filtering at 305 the line sections 348-350 (or, alternatively, the base image 346). The filtering process may include median filtering to remove image noise (e.g., random spots) and, in some instances, enhance the edges of the characters-of-interest.

The method 300 may also include analyzing at 306 the light intensity signals of each of the line sections to determine the character image portions of the corresponding line sections. To determine adjacent character image portions, the light intensity signals may be analyzed to designate a breakline between the adjacent character image portions. The breakline may separate the image data into character image portions.

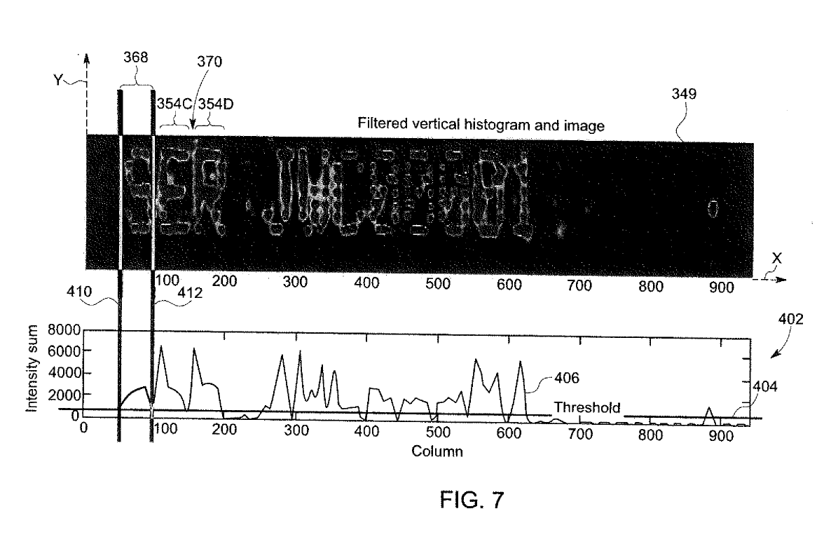

FIG. 7 illustrates a graph 402 aligned with the line section 349. The graph 402 show a relationship between columns of image pixels of the line section 349 and intensity sums of the columns. In particular embodiments, the analyzing operation at 306 includes summing the intensity signal of the image pixels in a column for at least a plurality of columns in the line section 349. The summed intensity signals for one column may be referred to as the intensity sum of the column. The columns of image pixels extend parallel to the Y-axis shown in FIG. 7 (or in a direction that is perpendicular to the character line 359). As shown in the graph 402, the columns of image pixels that include the characters-of-interest 354C, 354D will have relatively high intensity sums. However, the intensity sums of columns that correspond to the character spacing 370 will be relatively low.

In some embodiments, an approximate size of the character spacing 370 and/or a width of the characters-of-interest 354 may be known by the system 100 (or the segmentation module 116). For example, the size of the character spacing 370 or the width of the characters-of-interest 354 may be identified through the type of object, the manufacturer, and the like. In other embodiments, an operator of the system 100 may enter inputs that identify an approximate size of the character spacing 370 and/or the width of the characters-of-interest 354. When the system 100 analyzes the intensity sums of the columns of image pixels, the system 100 may determine a threshold 404 to identify those columns that are associated with the characters-of-interest 354 and those columns that are associated with the character spacing 370.

The graph 402 shows a relationship or signal trace 406 that is a function of the columns and the intensity sums. In some embodiments, the threshold 404 is a dynamic threshold 404 that is capable of changing as the segmentation module 116 analyzes the image pixels. For example, the segmentation module 116 may search for series of columns that substantially equal the known size of the character spacing 370 and/or series of columns that substantially equal the width of the characters-of-interest 354. After determining the threshold 404, the segmentation module 116 may then identify the character image portions 368 of the image data. For example, the breaklines 410, 412 shown in FIG. 7 may approximately define one of the character image portions 368.

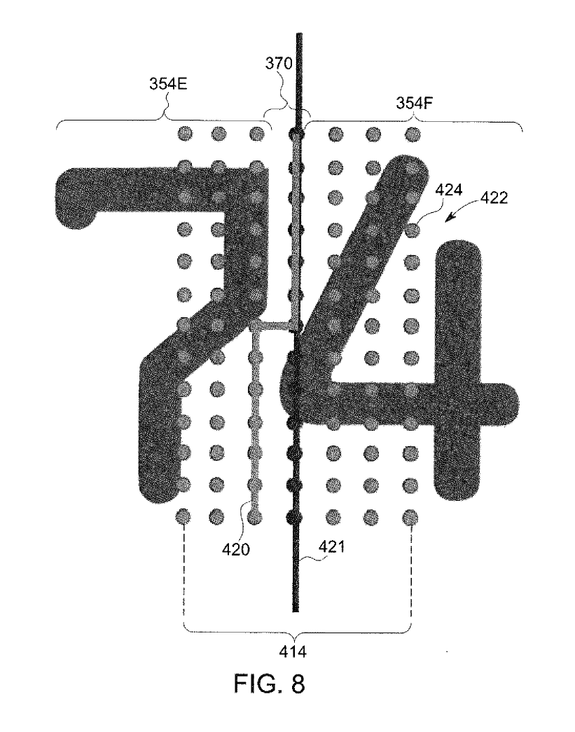

In some embodiments, the character image portions 368 are determined or identified as described above. However, in particular embodiments, the character image portions 368 are identified through a multi-step analysis. The first step may be an approximate determination of where adjacent character image portions should be separated. The first step may be similar to the determination of the breaklines 410, 412 described above. More specifically, the segmentation module 116 may identify a contiguous region 414 as shown in FIG. 8, wherein the contiguous region 414 corresponds to one of the breaklines determined by the segmentation module 116 as described above with respect to FIG. 7. As shown in FIG. 8, the contiguous region 414 includes portions of the characters-of-interest 354E and 354F and the character spacing 370. The segmentation module 116 may then determine another breakline 420 that extends through the contiguous region 414 between the characters-of-interest 354E, 354F. The breakline 420 may extend through the character spacing 370.

In some embodiments, a path of the breakline 420 is non-linear. In other words, the path may extend in at least two different directions. For example, in some cases, the characters-of-interest may partially overlap or be located immediately adjacent to each other such that a straight line (indicated by a dashed line 421) cannot extend between the two characters-of-interest without intersecting one of the characters-of-interest. To determine a non-linear path of the breakline 420, the segmentation module 116 may designate an array 422 of points 424. The array 422 of points 424 can be ordered in rows and columns. Each point 424 may correspond to one or more of the image pixels. The segmentation module 116 may analyze the light intensity signals of the image pixels that correspond to the points 424 and use a graph search algorithm to determine a short weighted path of the breakline 420. By way of one example, the algorithm may be based on Dijkstra's algorithm for calculating a shortest path between two points 424. After a path of the breakline 420 is determined, the segmentation module 116 may designate the path to separate the adjacent character image portions 368E, 368F.

The method 300 may also include determining at 307 a common dimension of the characters-of-interest in one of the line sections. The common dimension may represent a height of the characters-of-interest. The heights of the characters-of-interest are typically shorter than the heights of the corresponding character image portions. The difference between the heights of the characters-of-interest and the character image portions may correspond to extraneous areas of the character image portions that are not required for analysis. Accordingly, in some embodiments, identifying the common dimension of the characters-of-interest may facilitate removing the extraneous areas of the character image portions.

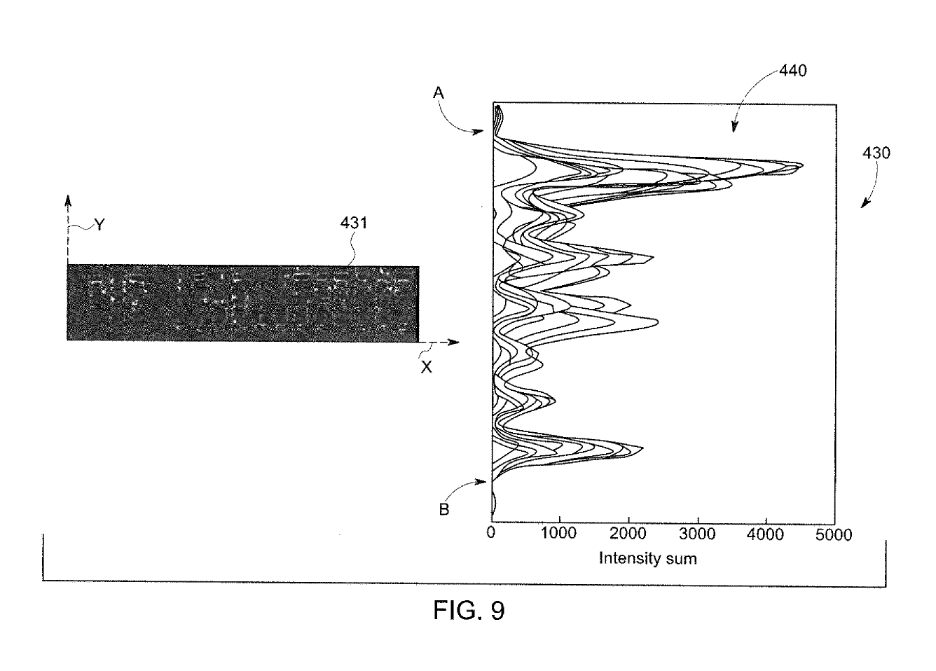

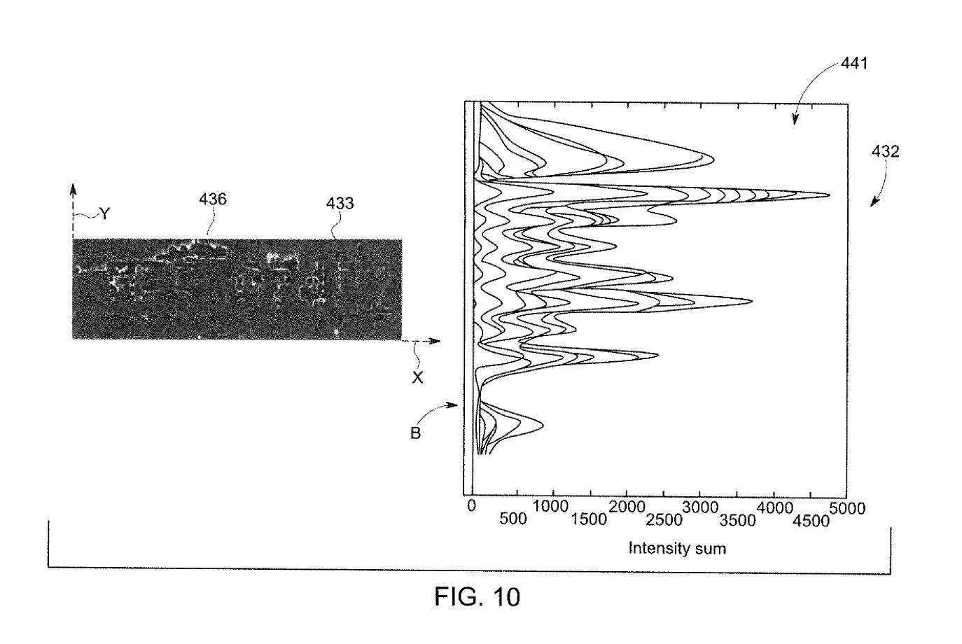

To determine the common dimension, the determining operation at 307 may include analyzing the light intensity signals of the image pixels of the character image portions. By way of one example, FIGS. 9 and 10 shows graphs 430, 432, respectively, that correspond to line sections 431, 433, respectively. Each of the line sections 431, 433 includes a plurality of character image portions. In the illustrated embodiment, the line section 431 includes fifteen (15) character image portions, and the line section 433 includes eight (8) character image portions.

The graphs 430, 432 show a relationship between rows of image pixels and intensity sums of the rows for each of the character image portions. As such, the graph 430 includes multiple signal traces 440 in which each signal trace 440 corresponds to one of the character image portions. As described above, the line sections and character image portions include at least a portion of the line spacing(s) between adjacent character lines. In some cases, scratches or other morphological changes may occur within the line spacing. For instance, the line section 431 does not include any significant morphological changes below or above the characters-of-interest, but the line section 433 includes a morphological change 436 above some the characters-of-interest. The morphological change 436 may be a scratch that extends along the X-axis and through a portion of the character line. More specifically, the morphological change 436 extends through characters M, F, and R in the line section 433. Since the characters M, F, and R are formed by morphological changes in a surface of an object, the morphological change 436 may render the character M, F, and R more difficult to read by the system 100. In such embodiments, the system 100 is configured to remove at least portions of the morphological change 436.

To this end, the segmentation module 116 may analyze the light intensity signals of the image pixels for each of the character image portions in one of the line sections. As illustrated in the graph 430, the signal traces 440 are shown in which each signal trace 440 indicates a relationship of the intensity sums to the row positions for the corresponding character image portion. Each signal trace may define a height dimension that is measured between two columns having intensity sums that are below a predetermined threshold (not shown). As shown, each signal trace 440 extends approximately from a limit A to a limit B in a Y-axis of the graph 430. The limit A may represent a column number where the intensity sum of the column number is below a threshold. Likewise, the limit B may represent a column number where the intensity sum of the column number is below a threshold. For each signal trace, the difference between the column number associated with limit A and the column number associated with limit B may represent the height dimension of the corresponding character-of-interest.

In some embodiments the limits A and B are determined by setting a predetermined threshold of the intensity sum. To determine a common dimension, the limit A may occur where a predetermined percentage (e.g., 70%) of the signal traces 440 are below the threshold. Likewise, the limit B may occur where a predetermined percentage (e.g., 70%) of the signal traces 440 are below the threshold. In FIG. 9, all of the signal traces 440 are below the threshold at limits A and B.

However, FIG. 10 illustrates an example where a predetermined percentage of signal traces 441 do not satisfy the threshold for limit A. It should be noted that the limit B has been determined in FIG. 10 because a predetermined percentage of signal traces 441 do satisfy the threshold at limit B. In those line sections that include morphological changes in the line spacings, such as the morphological change 436, a predetermine percentage of the signal traces below the thresholds may never be satisfied to determine both limits. In such cases, a mean of the height dimensions of the characters-of-interest may be determined. The mean may be compared to each one of the height dimensions and the outliers may be removed from the analysis of the common dimension. The common dimension may then be determined in a similar manner as described above (e.g., by determining where at least 70% of the remaining signal traces are below the threshold).

In some embodiments, determining the limits A and B for the line section 433 may be facilitated by user inputs. For example, an operator of the system 100 may enter inputs that directly or indirectly identify, for example, a height of the characters-of-interest. After determining the common dimension, the method 300 may include removing at 308 extraneous areas of the character image portions based on the common dimension of the characters-of-interest thereby providing trimmed image portions.

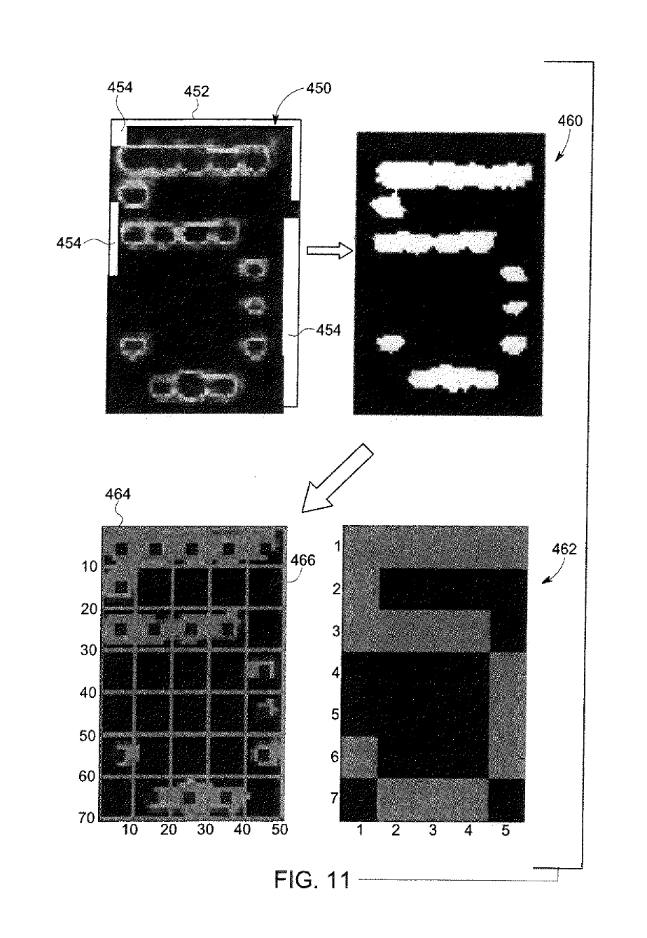

The method 300 also includes padding at 309 the trimmed image portions. FIG. 11 illustrates an exemplary trimmed image portion 450. The trimmed image portion 450 may have uneven borders due to the designation of breaklines and/or the removal of extraneous areas. In some embodiments, it may be desirable to provide an image portion that has predetermined dimensions (e.g., 70×50 image pixels). Thus, to pad the trimmed image portion 450, the trimmed image portion 450 may be centered in a frame 452. The frame 452 may have the desired dimensions (e.g., 70×50 image pixels) for subsequent analysis. As shown, when the trimmed image portion 450 is centered within the frame 452 a plurality of cut-outs 454 may exist within the frame 452. The cut-outs correspond to image pixels that are not filled by corresponding image pixels of the trimmed image portion 450. The segmentation module 116 may pad the cut-outs by filling in light intensity signals at the missing image pixels.

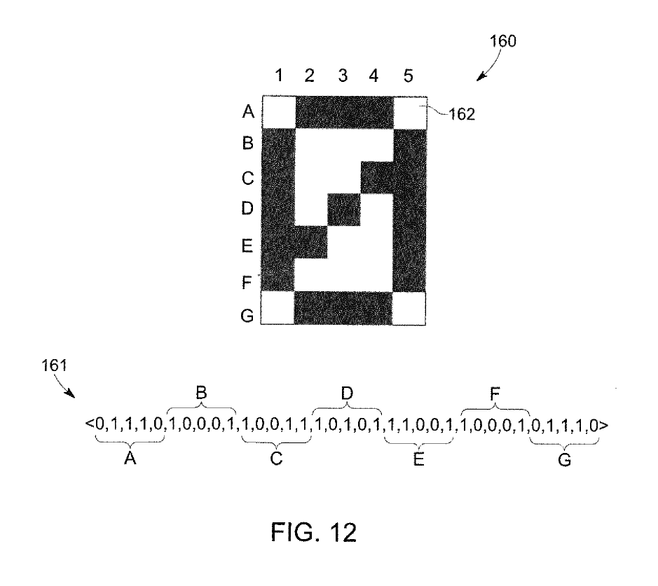

After padding at 309 the trimmed image portion 450, the padded image portion (not shown) may be binarized at 310. To binarize the padded image portion, the segmentation module 116 may compare the light intensity signals of the padded image portion to a predetermined threshold intensity signal. If the light intensity signal of the image pixel exceeds the threshold, the image pixel can be assigned a first value (e.g., 1). If the light intensity signal of the image pixel is less than the threshold, the image pixel can be assigned a different second value (e.g., 0). If the light intensity signal is equal to the threshold, the image pixel can be assigned the first or second value. A resulting binarized image portion 460 is shown in FIG. 12.

Although the pixelization/binarization process described above assigns each image pixel with one of two values, other pixelizing processes may use a different number of values (e.g., 1 of N values). For example, there can be three possible values depending upon the light intensity signal of the image pixel. Moreover, the pixelization process can be modified in other manners if desired. For example, instead of only considering the light intensity signal of the image pixel, the light intensity signals of adjacent image pixels may be considered when assigning a value.

After obtaining the binarized image portion 460, the resulting image portion may be compressed at 311 to provide a compressed binary image 462. For example, the binarized image portion 460 may be trimmed further to remove extraneous areas around the character-of-interest. The binarized image portion 460 can then be centered within a grid 464 of cells 466. In the illustrated embodiment, the grid 464 is 70 image pixels by 50 image pixels (70×50), wherein each cell 466 is 10×10 with a 100 image pixels therein. The binarized image portion 460 may be fitted within the grid 464 by resizing the binarized image portion 460. For example, the resizing may be accomplished using a nearest neighbor interpolation algorithm. However, other methods may be used for trimming and/or centering the binarized image portion 460 within the grid 464.

As shown in FIG. 11, at least some of the cells 466 include white image pixels and at least some of the cells 466 include black image pixels. The number and arrangement of cells 466 may correspond to a number and arrangement of coordinates of a feature vector 161 (FIG. 12), which is described in greater detail below. For each cell 466, a corresponding sum value of the image pixels may be determined and compared to a threshold value. For example, if each cell includes 100 image pixels, each image pixel that is white increments the sum value by one and each image pixel that is black does not increment the sum value. As a more specific example, if one of the cells 466 includes 73 white image pixels and 27 dark image pixels, then the corresponding sum value is 73 units. The sum value may be compared to the threshold value (e.g., 50 units) and then assigned a pixel value. In this example, the pixel value indicates that the cell 466 is white in the resulting compressed binary image 462.

FIG. 12 shows a compressed binary image 160 having an array of cells 162. The binary image 160 may be determined as described above with respect to the method 300. However, the binary image 160 may be obtained in other manners. The segmentation module 116 may also be configured to convert binary (or pixel) images into feature vectors. As such, the segmentation module 116 may also be referred to as a vector-generating module. As shown in FIG. 12, the array of cells 162 are arranged in rows A-G and columns 1-5, but other arrangements may be used. Each cell 162 has a cell location and a cell value. With respect to FIG. 12, the binary image 160 may be converted by the segmentation module 116 into a feature vector 161. The feature vector 161 is illustrated as including a string or set of 1's and 0's. In some embodiments, the segmentation module 116 analyzes each row of cells 162 in the binary image 160. Alternatively, the segmentation module 116 may analyze each column of cells 162.

Each cell 162 has a cell location that can be defined by the row and column of the cell 162. As shown, row A includes cells that exceeded the predetermined threshold as discussed above (indicated in black) and also cells that did not exceed the threshold (indicated in white). Specifically, cell A1 has a cell value of 0; cell A2 has a cell value of 1; cell A3 has a cell value of 1; cell A4 has a cell value of 1; and cell A5 has a cell value of 0. Rows B-G have cells 162 with cell values as indicated. As shown in the feature vector 161, the string of cell values in the feature vector 161 is based on the cell locations and the values of the cells. As such, the cell values may be referred to as coordinates in the feature vector and the series of coordinates may constitute a vector address 165 of the feature vector 161. For example, the first three coordinates in the feature vector 161 (or the vector address 165) have values that are derived from the cells A1, A2, A3 . . . and the last three coordinates have values that are derived from the cells G3, G4, G5. Thus, the vector address 165 is at least partially defined by (a) the cell locations and (b) the values of the cells.

In some SDM algorithms used in various embodiments, the feature vector (or input vector) includes the vector address 165 and a data pattern. For example, the vector address 165 of the feature vector 161 is: 0, 1, 1, 1, 0, 1, 0, 0, 0, 1, 1, 0, 0, 1, 1, 1, 0, 1, 0, 1, 1, 1, 0, 0, 1, 1, 0, 0, 0, 1, 0, 1, 1, 1, 0. In an exemplary embodiment, the vector address 165 and the data pattern of the feature vector 161 are the same (i.e., the series of coordinates may also be the data pattern). This may be referred to as the autoassociative mode. Although the illustrated embodiment uses an autoassociative protocol, other embodiments may have different values representing the vector address and the data pattern. For example, the vector address may be a three-digit number and the data pattern may be the same as shown in FIG. 12. In other embodiments, the data pattern may include the series of coordinates that constitute the vector address as well as additional information.

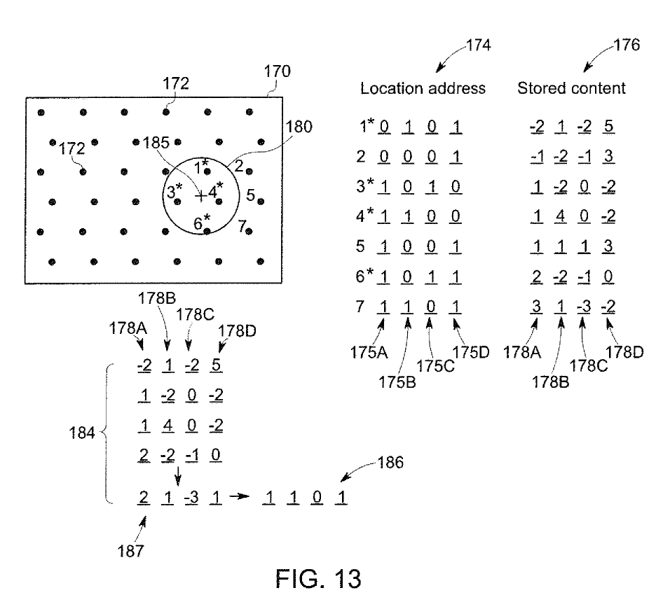

FIG. 13 illustrates how the system 100 may provide a suggested identity of a character-of-interest. FIG. 13 includes a representative view of the SDM module 118, which includes hard locations 172. Each of the hard locations 172 has a stored vector location address 174 and stored content counters 178. The SDM module 118 may be characterized as having an address space 170 where the hard locations 172 are located (only a portion of the address space 170 is shown in FIG. 13). The address space 170 may be considered a range of possible addresses of the hard locations 172 or the feature vectors 161. For example, the address space 170 is at least partially based on the number of coordinates in the feature vector 161. In particular embodiments, the address space 170 may be based on a total number of possible vector addresses. For example, the feature vector 161 includes a set of thirty-five (35) coordinates, wherein each coordinate has a possible value of 0 or 1. Thus, the total number of possible vector addresses in this example is 2³⁵ or approximately 35 billion addresses.

As shown in FIG. 13, the address space 170 has a plurality of the hard locations 172 that are distributed within the address space 170. For example, the hard locations 172 may have a binomial distribution with the address space 170. The hard locations 172 may be used to identify the character(s)-of-interest based on the sparse distributed memory techniques described herein. A total number of hard locations 172 can be relatively small or sparse compared to the total number of possible addresses. For example, the address space 170 may have 1.4 million hard locations 172 out of a total of approximately 35 billion locations in the address space 170. In an exemplary embodiment, the hard locations 172 are substantially evenly distributed throughout the address space 170. However, in other embodiments, the hard locations 172 may be unevenly distributed with respect to one another in the address space 170. The stored vector location address 174 of each hard location 172 may have the same number of coordinates 175 of the feature vector 161. However, for illustrative purposes in FIG. 13, the stored vector location address 174 of each hard location 172 has only four coordinates 175A-175D. The stored content counters 178A-178D include a number of counters that equals the number of coordinates 175 in the hard location 172 and in the feature vector 161. Again, for illustrative purposes, only four counters 178A-178D are shown in FIG. 13 for each hard location 172.

In some embodiments, the system 100 is configured to train the SDM module 118. Alternatively, a previously trained or modified SDM module 118 may be provided to the system 100. To train the SDM module 118, the system 100 may scan numerous objects (e.g., tens or hundreds) having markings thereon and convert the markings into feature vectors as described above. The feature vectors may then be written or stored into the SDM module 118 to train the SDM module 118 in identifying characters-of-interest. More specifically, the identification module 117 may determine a relative distance between the vector address 165 of the feature vector 161 and at least some of the stored vector location addresses 174 of the hard locations 172. In some embodiments, the identification module 117 determines a relative distance between the vector address 165 and each one of the stored vector location addresses 174 of the hard locations 172. By way of illustration, the vector address of the feature vector to-be-stored, such as the feature vector 161, is represented in the address space 170 as cross-hairs 185. As shown, the cross-hairs 185 are located relatively close to the hard locations 172 that are indicated as numbers (nos.) 1, 3, 4, and 6 in the address space 170.

The identification module 117 may determine the relative distance between the feature vector to-be-stored and the hard locations 172 using various algorithms. The relative distance may be determined by calculating, for example, the Hamming distance between the feature vector to-be-stored and one of the hard locations 172. Other exemplary algorithms for calculating the relative distances include the Manhattan distance and the Euclidean distance. The Hamming distance essentially determines the number of coordinates in the feature vector to-be-stored that have a different value than the corresponding coordinates 175 of the stored location address of each of the hard locations 172. Using the hard locations 172 as an example of calculating the Hamming distance, the Hamming distance between the hard location no. 1 and hard location no. 2 is 1 unit, because the hard locations nos. 1 and 2 only differ at the second coordinate 175B. The relative distance between the hard location no. 1 and the hard location no. 3 is 4 units, because the hard locations nos. 1 and 3 differ at all four coordinates 175A-175D.

The identification module 117 may then compare the calculated relative distance associated with the hard locations 172 to a predetermined distance or threshold value. The circle 180 that surrounds the hard locations nos. 1, 3, 4, and 6 in FIG. 13 may represent the predetermined distance value. The hard locations 172 that are within the predetermined distance (i.e., the hard locations nos. 1, 3, 4, and 6) are considered to be “activated” and, as such, those hard locations 172 may be referred to as activated locations. The activated locations are indicated with asterisks in FIG. 13.

After identifying the activated locations from the hard locations 172, the data pattern of the queried feature vector can then be stored into the stored content counters 178 for those hard locations 172 that are activated. For example, the stored content counters 178 may be incremented and/or decremented. Each counter 178A-178D corresponds to one of the coordinates (e.g., the counter 178A corresponds to the coordinate 175A, the counter 178B corresponds to the coordinate 175B, and so on). According to one embodiment, for each coordinate in the feature vector to-be-stored that has a value of 1, the corresponding counter 178 increases by 1 (or incremented by 1). For each coordinate having a value of 0, the corresponding counter 178 decreases by 1 (or decremented by 1). By way of one particular example, if the data pattern of the feature vector to-be-stored was <1, 0, 1, 0>, then, for each one of the activated locations, the first counter 178A would add one to its total; the second counter 178B would subtract one from the corresponding total; the third counter 178C would add one to the corresponding total; and the fourth counter 178D would subtract one from the corresponding total. After numerous feature vectors have been stored into the SDM module 118, the stored content counters 178 of the hard locations nos. 1-7 might be as shown in FIG. 13.

The identification module 117 is also configured to provide a suggested identity of the character(s)-of-interest. In other words, the identification module 117 may identify (or provide a better estimation of) the character-of-interest to the user of the system 100. In some embodiments, the identification module 117 may use a feature vector to retrieve an output vector that is then used to provide the suggested identity. The identification operation is similar to the training operation discussed above. However, the SDM module 118 is typically already trained or modified in some manner before the system 100 is used to analyze markings on objects.

Again, the feature vector being applied to the SDM module 118 during the identification operation may be represented as the cross-hairs 185 in the address space 170. The location of the cross-hairs 185 is based on the vector address of the feature vector, which can be determined by the segmentation module 116. As before, the identification module 117 may determine the relative distance between the feature vector and the hard locations 172 (e.g., by calculating the Hamming distance or through other algorithms, such as Manhattan or Euclidean). The identification module 117 then compares the calculated relative distances to a predetermined distance value to identify the activated locations. Again, the hard locations nos. 1, 3, 4, and 6 in FIG. 13 may represent the activated locations. It should be noted that the predetermined distance value for storing feature vectors and the predetermined distance value for retrieving output vectors are not required to be the same. For example, storing a feature vector may only require a Hamming distance of 4, but retrieving an output vector may require a Hamming distance of 3.

In some embodiments, to provide the suggested identity of the character-of-interest, the stored content counters 178 of the activated locations are then summed-and-thresholded as indicated at reference numeral 184. More specifically, the counters 178A of the activated locations are combined (e.g., summed or added together); the counters 178B of the activated locations are combined; the counters 178C of the activated locations are combined; and the counters 178D of the activated locations are combined. The resulting vector may be referred to as a summed-content vector 187 that includes a set of values. As shown in FIG. 13, the exemplary summed-content vector from the summing operation is <2, 1, −3, 1>. The number of values in the set of values is equal to the number of coordinates in the feature vector.

According to one embodiment, each of the sums is then compared to a threshold to provide an output vector 186. For example, if the value in the summed-content vector 187 is greater than a threshold value of zero, a value of 1 is provided in the corresponding output vector 186. If the value in the summed-content vector 187 is less than a threshold value of zero, a value of 0 is provided in the corresponding output vector 186. If the value is equal to zero, values of 0 or 1 can be provided in the corresponding output vector 186. In the illustrated example, the output vector 186 has values of <1, 1, 0, 1>. In other embodiments, a threshold value other than zero may be used.

Accordingly, in some embodiments, the feature vector in the training and retrieval operations may facilitate identifying a select number of the hard locations 172 as activated locations in the address space 170 of the SDM module 118. The stored content counters of the activated locations may then be used to generate a single output vector 186. The output vector 186 is based on the stored content counters of the activated locations that, in turn, can be based on previously stored feature vectors.

In some embodiments, the output vector 186 may be converted into a binary image, such as the binary image 160, using a similar cell location and value standard as described above. More specifically, each coordinate in the output vector 186 having a value of 1 will correspond to a cell that is black and each coordinate having a value of 0 will correspond to a cell that is white. The binary image 160 may then be provided to the user through, for example, the user interface 122. In such embodiments, the suggested identity may include some noise. In other embodiments, the output vector 186 may undergo further analysis or processing to determine an ideal character that the output vector is closest to that does not include noise. The ideal character may then be provided to the user interface 122. Accordingly, the suggested identity shown to the user may or may not correspond to the ideal character.

FIG. 15 illustrates exemplary binary images 191-193 of characters-of-interest that may be identified by various embodiments described herein. As shown, the binary images 191-193 do not include ideal representations. For example, the physical markings corresponding to the binary images 191-193 may have been physically damaged (e.g., scratched, worn), or the physical markings may have collected dust or other material. Embodiments described herein are configured to analyze image data of the physical markings and provide output representations 194-196 that indicate the identity of the characters-of-interest.

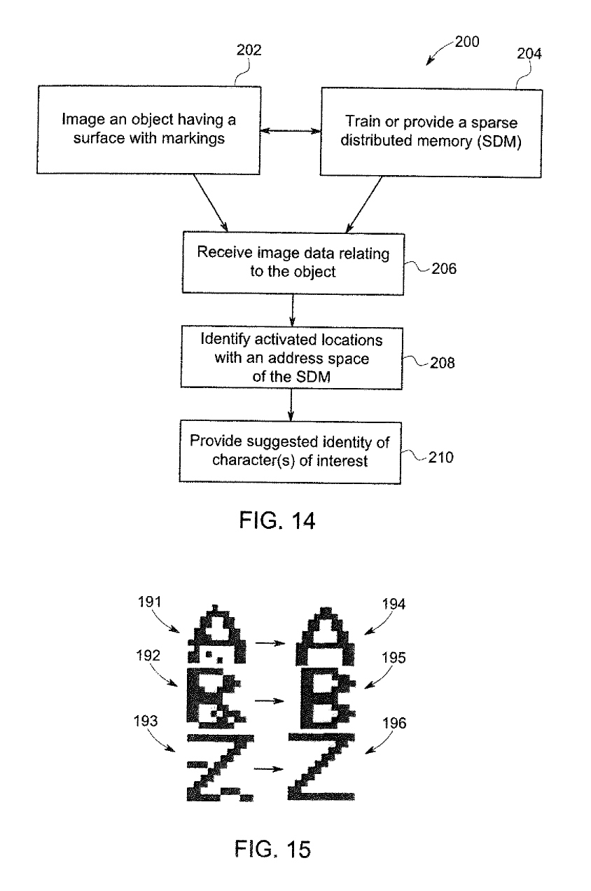

FIG. 14 is a flowchart illustrating a method 200 of identifying characters from an object having physical markings. The method 200 may be implemented by the system 100. A non-transitory computer readable medium may also include instructions to command a processor to perform the method 200. The method 200 includes imaging at 202 an object having a surface with markings thereon. The markings may be physical markings. The imaging operation at 202 may include using an imager, such as the imager 104, or other camera system to acquire an image of the physical markings on the object. In an exemplary embodiment, the imager or camera system is part of a system or device that is dedicated almost exclusively to character-recognition and to communication of the suggested characters. However, in other embodiments, the system or device may be used for various applications. By way of one example only, the system or device may be a personal communication device, such as a smart phone, or a portable computer (e.g., laptop, tablet, and the like). The personal communication device or the portable computer can have a software application for character-recognition stored in the device or computer. The imager could be a camera system that is integrated with the device or computer. Alternatively, additional components for imaging could be removably attached to the device or computer.

Before or after the imaging operation at 202, the SDM can be trained or provided at 204. In one example, the SDM can be trained using the images acquired by the system as described above with respect to FIG. 13. Alternatively, previously-acquired image data may be received from a stored database. For instance, if the user desired to train the SDM in a particular manner, the user could request that the SDM be trained with feature vectors that are derived from physical markings found on a particular type of object. Objects of a particular type may be marked in a similar manner. For example, same-type objects may be marked in the same way (e.g., dot peened) and in the same manner (e.g., 5×7 matrix). The user could be even more particular and request feature vectors of objects that have been marked by one particular machine, because that machine may have A's (or other alphanumeric characters) that are unique to A's of other machines of the same type. The user may specify the request in other manners as well.

In other embodiments, the training operation at 204 may constitute receiving an SDM. More specifically, the training operation at 204 may include receiving an SDM that has been previously trained or modified in some manner. For example, the stored content counters of the hard locations in the trained SDM may already have particular values. As such, the time necessary to train the SDM by repeatedly storing feature vectors may be avoided. The SDM may be configured for a particular object. By way of one particular example only, an SDM may be trained for rotors that were manufactured in a particular year at one plant. It should be noted that the training operation at 204 may or may not be performed.

The method 200 may also include receiving at 206 image data that relates to the object having characters-of-interest. The image data may be received from the imager or other camera system immediately after acquisition of the image, or the image data can be received from a database. After receiving the image data, the image data may be analyzed at 208 to convert at least one of the characters-of-interest into a corresponding feature vector as described above.

With the SDM, the method 200 includes identifying at 208 activated locations by determining a relative distance between the feature vectors and the stored vector location addresses of the hard locations. As described above, non-limiting examples of the relative distance include the Hamming distance, the Manhattan distance, or the Euclidean distance. Regardless of the manner in calculating the relative distance, the activated locations may be determined by comparing the calculated relative distances to a predetermined distance value.

The method 200 also includes providing a suggested identity at 210 of the character(s)-of-interest based on the stored content counters of the activated locations as described above. The suggested identity may be generated from an output vector provided by the SDM. The suggested identity may be a character that includes some noise or an ideal character without any noise.

At least one technical effect of some embodiments is the removal of undesirable portions of an acquired image to facilitate identifying a character-of-interest in the image. Another technical effect may be the separation or isolation of characters-of-interest in the image data so that the characters-of-interest may be more easily identified. At least one other technical effect may be identifying a character-of-interest using an SDM module in which the character-of-interest has been damaged, dirtied, or are otherwise rendered more difficult to read.

The various components and modules described herein may also be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer” or “module”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program, which may form part of a tangible, non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, the embodiments are by no means limiting and are exemplary embodiments. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A character-recognition system comprising:
an imager configured to acquire an image of an object, the acquired image including a surface of the object having characters-of-interest thereon that are arranged along multiple characters lines, the characters-of-interest being defined by morphological changes in the surface; and
a segmentation module configured to obtain image data based on the acquired image, the image data including a plurality of image pixels having corresponding light intensity signals, the light intensity signals being based on whether the corresponding image pixel correlates to one of the morphological changes in the surface of the object, the segmentation module also configured to:
determine a line section of the image data, the line section including one of the character lines and having character image portions, the character image portions including corresponding characters-of-interest therein;
analyze the light intensity signals of the image pixels in the character image portions to determine a common height of the characters-of-interest in the corresponding character line of the line section; and
remove extraneous areas of the character image portions based on the common height of the characters-of-interest to provide trimmed image portions.

2. The system of claim 1, further comprising an identification module, wherein the segmentation module is configured to provide feature vectors to the identification module, the feature vectors based on the trimmed image portions and having a predetermined number of coordinates, the identification module using the feature vectors and a sparse distributed memory (SDM) algorithm to provide suggested identities of the characters-of-interest.

3. The system of claim 1, wherein the line section includes a plurality of line sections and said determining operation includes analyzing the intensity signals of the image pixels to determine a line spacing between adjacent character lines, wherein different line sections include different character lines.

4. The system of claim 3, wherein said analyzing the intensity signals of the image pixels includes summing the intensity signals of a plurality of rows of image pixels, each row extending parallel to the character lines, wherein the line spacing corresponds to rows having an intensity sum that is less than a threshold, and the character lines correspond to rows having an intensity sum that is greater than a threshold.

5. The system of claim 1, wherein the segmentation module is also configured to analyze the light intensity signals of the line section to designate a breakline that separates adjacent character image portions.

6. The system of claim 1, wherein the segmentation module is also configured to analyze the light intensity signals of the line section to determine the character image portions, said analyzing the light intensity signals of the line section including:
identifying a contiguous region of the image data that includes adjacent characters-of-interest and a character spacing there between; and
designating a breakline that separates the adjacent character image portions, the breakline extending through the contiguous region.

7. The system of claim 6, wherein said designating includes analyzing image pixels of the contiguous region and using a graph search algorithm to calculate a path of the breakline.

8. The system of claim 7, wherein the path extends in at least two different directions.

9. A non-transitory computer readable medium for segmenting an acquired image of an object using at least one processor, the image including a surface of the object having characters-of-interest thereon that are arranged along multiple characters lines, the computer readable medium including instructions to command the processor to:
obtain image data of the surface of the object, the image data comprising a plurality of image pixels having corresponding light intensity signals, the light intensity signals being based on whether the corresponding image pixel correlates to a morphological change in the surface of the object;
determine a line section of the image data, the line section including one of the character lines and having character image portions, the character image portions including corresponding characters-of-interest therein;
analyze the light intensity signals of the image pixels in the character image portions to determine a common height of the characters-of-interest in the corresponding character line of the line section; and
remove extraneous areas of the character image portions based on the common height of the characters-of-interest to provide trimmed image portions.

10. The computer readable medium of claim 9, wherein the processor is also configured to provide feature vectors having a predetermined number of coordinates based on the trimmed image portions, the feature vectors configured to be processed in a sparse distributed memory (SDM) algorithm to identify the characters-of-interest in the respective trimmed image portions.

11. The computer readable medium of claim 9, wherein the line section includes a plurality of line sections and said determining operation includes analyzing the intensity signals of the image pixels to determine a line spacing between adjacent character lines, wherein different line sections include different character lines.

12. The computer readable medium of claim 11, wherein said analyzing the intensity signals of the image pixels includes summing the intensity signals of a plurality of rows of image pixels, each row extending parallel to the character lines, wherein the line spacing corresponds to rows having an intensity sum that is less than a threshold, and the character lines correspond to rows having an intensity sum that is greater than a threshold.

13. The computer readable medium of claim 9, wherein the processor is also commanded to analyze the light intensity signals of the line section to designate a breakline that separates adjacent character image portions.

14. The computer readable medium of claim 9, wherein the processor is also commanded to analyze the light intensity signals of the line section to determine the character image portions, said analyzing the light intensity signals of the line section including:
identifying a contiguous region of the image data that includes adjacent characters-of-interest and a character spacing there between;
designating a breakline that separates the adjacent character image portions, the breakline extending through the contiguous region.

15. The computer readable medium of claim 14, wherein said designating includes analyzing image pixels of the contiguous region and using a graph search algorithm to calculate a path of the breakline.

16. The computer readable medium of claim 15, wherein the path extends in at least two different directions.

17. A method of processing an acquired image to identify characters-of-interest in the acquired image, the method comprising:
obtaining image data of a surface of an object, the image data including a plurality of image pixels having corresponding light intensity signals, the light intensity signals being based on whether the corresponding image pixel correlates to a morphological change in the surface of the object;
determining a line section of the image data, the line section including one of the character lines and having character image portions, the character image portions including corresponding characters-of-interest therein;
analyzing the light intensity signals of the image pixels in the character image portions to determine a common height of the characters-of-interest in the corresponding character line of the line section; and
removing extraneous areas of the character image portions based on the common height of the characters-of-interest to provide trimmed image portions.

18. The method of claim 17, further comprising providing feature vectors having a predetermined number of coordinates based on the trimmed image portions, the feature vectors configured to be processed in a sparse distributed memory (SDM) algorithm to identify the characters-of-interest in the respective trimmed image portions.

19. The method of claim 17, wherein the line section includes a plurality of line sections and said determining operation includes analyzing the intensity signals of the image pixels to determine a line spacing between adjacent character lines, wherein different line sections include different character lines.

20. The method of claim 17, wherein said analyzing the intensity signals of the image pixels includes summing the intensity signals of a plurality of rows of image pixels, each row extending parallel to the character lines, wherein the line spacing corresponds to rows having an intensity sum that is less than a threshold, and the character lines correspond to rows having an intensity sum that is greater than a threshold.

21. The method of claim 17, further comprising analyzing the light intensity signals of the line section to designate a breakline that separates adjacent character image portions.
